(19) United States
(12) Patent Application Publication
(10) Pub. No.: US 2019/0244207 A1
(43) Pub. Date: Aug. 8, 2019

(54) SYSTEMS, METHODS AND MACHINE-READABLE MEDIUMS FOR BLOCKCHAIN ENFORCED CONDITIONAL TRANSFER OF CRYPTOCURRENCY

(71) Applicant: EHAB SAMUEL, MANHATTAN BEACH, CA (US)

(72) Inventor: EHAB SAMUEL, MANHATTAN BEACH, CA (US)

(21) Appl. No.: 16/264,627

(22) Filed: Jan. 31, 2019

Related U.S. Application Data
(60) Provisional application No. 62/625,963, filed on Feb. 2, 2018.

(51) Int. Cl. G06Q 20/40; G06Q 20/38; G06Q 20/06

(52) U.S. Cl. CPC G06Q 20/405; G06Q 20/3829; G06Q 2220/00; G06Q 20/389; G06Q 20/0658

(57) ABSTRACT

Systems, methods and machine-readable mediums for blockchain enforced conditional transfer of an asset, such as a cryptocurrency, are provided. The system may comprise a smart contract comprising at least one condition relating to the automated generation of one or more blockchain transactions to enable a transfer to be made with respect to the asset. The at least one condition defines a permitted use of the asset. The permitted use corresponding to a permitted category selected from a group consisting of permitted location-based identifiers of a transferee, permitted businesses, permitted transaction price and permitted time period. The automated generation of one or more blockchain transactions to enable a transfer of the asset occurs if a transaction category complies with the permitted category. The system may further comprise one or more processors adapted to execute the at least one condition of the smart contract.

### CROSS REFERENCE TO RELATED APPLICATION

This patent document claims the benefit of and priority to U.S. Provisional Application Ser. No. 62/625,963, filed Feb. 2, 2018, the contents of which are incorporated herein by reference in their entirety and are considered a part of the specification, and which incorporates by reference in their entirety for all purposes U.S. patent application Ser. No. 15/728,507, filed Oct. 10, 2017, and U.S. Provisional Application Ser. No. 62/406,371, filed Oct. 10, 2016.

### FIELD

The present disclosure relates generally to systems, methods and machine-readable mediums for conditional transfer of an asset, such as a cryptocurrency. More particularly, this disclosure relates to improved systems, methods and machine-readable mediums for verification, enforcement and/or performance of processes, for example, associated with smart contracts or through a smart contract to control and/or restrict the transfer of an asset, such as a cryptocurrency.

### BACKGROUND

“Smart contracts” are computerized transaction protocols that execute the terms of a contract. The computerized transaction protocols, implemented in lines of code, represent agreements that are automatically conducted by computing devices or blockchain nodes. Once the smart contract is executed, the blockchain ledger is updated and the network may then verify the completion of the contract. Smart contracts may be used to allow for the automatic transfer of digital assets, such as cryptocurrency, between parties on a decentralized network.

Despite the improvements in blockchain technology over the years, there remains inherent problems with the technology that impairs its ability to be more widely used as a digital asset among businesses for the purchase of goods and/or services. One inherent problem is the volatility of the price of cryptocurrency on a cryptocurrency exchange, particularly when compared to flat currency. Because there is not a central bank of any particular country controlling the supply and value of cryptocurrency, its value may decrease significantly in a short period of time, resulting in significant losses to individuals or businesses. Another inherent problem is that, due to limited control of the cryptocurrency, several cryptocurrency exchanges have been hacked and billions of dollars in cryptocurrency have been stolen, raising concerns that the digital asset is used for financing illegal activity.

Accordingly, improved systems, methods and machine-readable mediums for verification, enforcement and/or performance of processes, for example, associated with smart contracts, to control and/or restrict the transfer of an asset, such as cryptocurrency, would be advantageous.

### SUMMARY

Systems, methods and machine-readable mediums for blockchain enforced conditional transfer of an asset, such as a cryptocurrency, are provided. Embodiments of the present disclosure may include a computer-implemented system for blockchain enforced conditional transfer of cryptocurrency. In one embodiment, the system may comprise an asset, a registry, a smart contract and one or more processors. The asset may comprise a plurality of private cryptographic keys, each private key being associated with an owner of the asset. The registry may comprise a plurality of public cryptographic keys wherein each public key corresponds to a private key in the asset's plurality of private keys, and is associated with a redeem script hash that can be identified within an unspent blockchain transaction. The smart contract may comprise at least one condition relating to the automated generation of one or more blockchain transactions to enable a transfer to be made with respect to the asset, the at least one condition defines a minimum price floor, whereby the automated generation of one or more blockchain transactions to enable a transfer of the asset occurs if a transaction price is greater than the minimum price floor. Moreover, the one or more processors may be programmed to execute the at least one condition of the smart contract.

In one embodiment, the automated generation of one or more blockchain transactions to enable a transfer of the asset does not occur if the transaction price is less than the minimum price floor. In yet another embodiment, the computer-implemented system further comprises a storage medium for storing a price of the asset at a particular time, the minimum price floor is a certain increment or percentage relative to the price of the asset at the particular time. In some embodiments, the minimum price floor is pegged to a price of a certain currency or commodity. In yet another embodiment, the at least one condition further defines a maximum price ceiling, the automated generation of one or more blockchain transactions to enable a transfer of the asset occurs if a transaction price is greater than the minimum price floor and less than the maximum price ceiling, and the minimum price floor and the maximum price ceiling are each at a certain increment or percentage relative to a price of the asset at a particular time.

Embodiments of the present disclosure may also include a smart contract that may include at least one condition relating to the automated generation of one or more blockchain transactions to enable a transfer to be made in respect of the asset, the at least one condition defines a permitted use of the asset, the permitted use corresponding to a permitted category selected from a group consisting of permitted location-based identifiers of a transferee, permitted businesses, and permitted time period. In one embodiment, the automated generation of one or more blockchain transactions to enable a transfer of the asset may occur if a transaction category complies with the permitted category. In another embodiment, the automated generation of one or more blockchain transactions to enable a transfer of the asset may not occur if the transaction category does not comply with the permitted category. As can be appreciated, the permitted category for permitted location-based identifiers may be at least one approved IP address, while the permitted category for permitted businesses may be based on a standard classification for businesses.

In one embodiment, the at least one condition may further define a minimum price floor, and the automated generation of one or more blockchain transactions to enable a transfer of the asset may occur if a transaction price is greater than the minimum price floor. In yet another embodiment, the system may include a storage medium for storing a price of the asset at a particular time, the minimum price floor may be at a certain increment or percentage relative to the price of the asset at the particular time. In another embodiment, the at least one condition may further define a maximum price ceiling, and the automated generation of one or more blockchain transactions to enable a transfer of the asset may occur if a transaction price is less than the maximum price ceiling. Further, in yet another embodiment, the system may include a storage medium for storing a price of the asset at a particular time, the maximum price ceiling may be a certain increment or percentage relative to the price of the asset at the particular time.

Computer-implemented methods of restricting a transfer made via a blockchain are also provided. In one embodiment, a method may include defining an asset comprising a plurality of private cryptographic keys, each private key being associated with an owner of the asset; and generating a registry comprising a plurality of public cryptographic keys wherein each public key corresponds to a private key in the asset's plurality of private keys, and is associated with a redeem script hash that can be identified within an unspent blockchain transaction. The method may further include generating a smart contract comprising at least one condition relating to the automated generation of one or more blockchain transactions to enable a transfer to be made in respect of the asset, the at least one condition defines a minimum price floor, the automated generation of one or more blockchain transactions to enable a transfer of the asset occurs if a transaction price is greater than the minimum price floor. Moreover, the method may also include using one or more processors to execute the at least one condition of the smart contract.

In one embodiment, the at least one condition further defines a maximum price ceiling, and the automated generation of one or more blockchain transactions to enable a transfer of the asset may occur if a transaction price is greater than the minimum price floor and less than the maximum price ceiling. In another embodiment, the method further includes retrieving a price of the asset at a particular time from a storage medium, and determining the minimum price floor as a certain increment or percentage relative to the price of the asset at the particular time.

In yet another embodiment, the at least one condition further defines a permitted use of the asset, the permitted use corresponding to a permitted category selected from a group consisting of permitted location-based identifiers of a transferee, permitted businesses, and permitted time period, and the automated generation of one or more blockchain transactions to enable a transfer of the asset occurs if a transaction category corresponds to the permitted category. In one embodiment, the automated generation of one or more blockchain transactions to enable a transfer of the asset does not occur if the transaction category does not comply with the permitted category. As can be appreciated, the permitted category for permitted location-based identifiers may be at least one approved IP address. In yet another embodiment, the method further includes verifying if the transaction category corresponds to the permitted category.

Non-transitory computer readable mediums are also provided. In one embodiment, a non-transitory computer readable medium may provide instructions, which when read by a computing device having a processor and a database, cause the computing device to perform operations comprising: defining an asset comprising a plurality of private cryptographic keys, each private key being associated with an owner of the asset; and generating a registry comprising a plurality of public cryptographic keys wherein each public key corresponds to a private key in the asset's plurality of private keys, and is associated with a redeem script hash that can be identified within an unspent blockchain transaction. The non-transitory computer medium may include instructions that cause the computing device to generate a smart contract comprising at least one condition relating to the automated generation of one or more blockchain transactions to enable a transfer to be made in respect of the asset, the at least one condition defines a minimum price floor, the automated generation of one or more blockchain transactions to enable a transfer of the asset occurs if a transaction price is greater than the minimum price floor. Moreover, the non-transitory computer medium may include instructions that cause the computing device to execute the at least one condition of the smart contract.

In some embodiments, the at least one condition further defines a maximum price ceiling, and the automated generation of one or more blockchain transactions to enable a transfer of the asset occurs if a transaction price is greater than the minimum price floor and less than the maximum price ceiling. In another embodiment, the non-transitory computer medium may include instructions that cause the computing device to retrieve a price of the asset at a particular time from a storage medium, and determine the minimum price floor as a certain increment or percentage relative to the price of the asset at the particular time.

In yet another embodiment, the at least one condition further defines a permitted use of the asset, the permitted use corresponding to a permitted category selected from a group consisting of permitted location-based identifiers of a transferee, permitted businesses, and permitted time period, and the automated generation of one or more blockchain transactions to enable a transfer of the asset occurs if a transaction category corresponds to the permitted category. In one embodiment, the automated generation of one or more blockchain transactions to enable a transfer of the asset does not occur if the transaction category does not comply with the permitted category. As can be appreciated, the permitted category for permitted location-based identifiers may be at least one approved IP address. In yet another embodiment, non-transitory computer medium may include instructions that cause the computing device to verify if the transaction category corresponds to the permitted category.

In another embodiment, a non-transitory computer-readable medium is provided. The non-transitory computer-readable medium provides instructions, which when read by a computer having a processor and a database, cause the computer to perform operations comprising: defining an asset comprising a plurality of private cryptographic keys, each private key being associated with an owner of the asset; generating a registry comprising a plurality of public cryptographic keys wherein each public key corresponds to a private key in the asset's plurality of private keys, and is associated with a redeem script hash that can be identified within an unspent blockchain transaction; generating a smart contract comprising at least one condition relating to the automated generation of one or more blockchain transactions to enable a transfer to be made in respect of the asset, the at least one condition defines a minimum price floor (PF) and/or a maximum price ceiling (PF), the automated generation of one or more blockchain transactions to enable a transfer of the asset occurs if a transaction price is greater than the minimum price floor (PF) and/or less than the maximum price ceiling (PC); and using a computing agent (i.e., a processor) to evaluate and/or execute the at least one condition of the smart contract.

In yet another embodiment, a non-transitory computer-readable medium is provided. The non-transitory computer-readable medium provides instructions, which when read by a computer having a processor and a database, cause the computer to perform operations comprising: defining an asset comprising a plurality of private cryptographic keys, each private key being associated with an owner of the asset; generating a registry comprising a plurality of public cryptographic keys wherein each public key corresponds to a private key in the asset's plurality of private keys, and is associated with a redeem script hash that can be identified within an unspent blockchain transaction; generating a smart contract comprising at least one condition relating to the automated generation of one or more blockchain transactions to enable a transfer to be made in respect of the asset, the at least one condition defines a permitted use of the asset, the permitted use corresponding to permitted categories selected from a group consisting of permitted location-based identifiers of a transferee, permitted businesses, and permitted time period, the automated generation of one or more blockchain transactions to enable a transfer of the asset occurs if a transaction category complies with (corresponds to) the permitted categories; and using a computing agent (i.e., a processor) to evaluate and/or execute the at least one condition of the smart contract.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 illustrates an exemplary flowchart outlining the operation of a system for the conditional transfer of an asset, such as a cryptocurrency, using a floating price floor (PF) and/or a floating price ceiling (PC), according to an embodiment of the present disclosure.

FIG. 2 illustrates an exemplary flowchart outlining the operation of a system for the conditional transfer of an asset, such as a cryptocurrency, to certain business(es) and/or field(s) of use, according to an embodiment of the present disclosure.

FIG. 3 illustrates an exemplary flowchart outlining the operation of a system for controlling the transfer of an asset, such as a cryptocurrency, to certain geographic territories based on location-based identifier(s), according to an embodiment of the present disclosure.

FIG. 4 illustrates an exemplary flowchart outlining the operation of a system for the conditional transfer of an asset, such as a cryptocurrency, within a certain transaction time period, according to an embodiment of the present disclosure.

### DETAILED DESCRIPTION

The following detailed description includes representative examples utilizing numerous features and teachings, both separately and in combination, and describes numerous embodiments that relate to systems, methods, and machine-readable mediums for verification, enforcement and/or performance of processes, for example, associated with smart contracts, to control and/or restrict the transfer of cryptocurrency. This detailed description is merely intended to teach a person of skill in the art further details for practicing one or more embodiments of the present disclosure and is not intended to limit the scope of the claims. Therefore, combinations of features disclosed in the following detailed description and incorporated documents may not be necessary to practice the teachings in the broadest sense, and are instead taught merely to describe particularly representative examples of the present teachings.

Some portions of the detailed description that follow are presented in terms of algorithms and sequences of operations, which are performed within a computer memory. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It should be borne in mind, however, that the algorithms and/or sequence of operations are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic device, that manipulates and transforms data represented as physical (electronic) quantities within the computer system's registers and memories into other data similarly represented as physical quantities within the electronic device's memory or registers or other such information storage, transmission or display devices.

Embodiments of the present disclosure include systems, methods and machine-readable mediums for verification, enforcement and/or performance of processes, for example, associated with smart contracts, to control and/or restrict the transfer of an asset, such as cryptocurrency. In one embodiment, the structures and functions of systems, methods and machine readable mediums for the creation, verification, implementation, execution and enforcement of smart contracts and/or for the transfer or trading of cryptocurrency or data, among others, may include, but is not limited to, those disclosed in U.S. Publ. No. 20170085545, WIPO Patent Application WO/2017/145019, WIPO Patent Application WO/2017/145007, U.S. Pat. Nos. 9,849,364, 9,785,369, 9,807,106, 9,794,074, and U.S. Publ. No. 2015/0332395, all of which are incorporated herein by reference in their entirety.

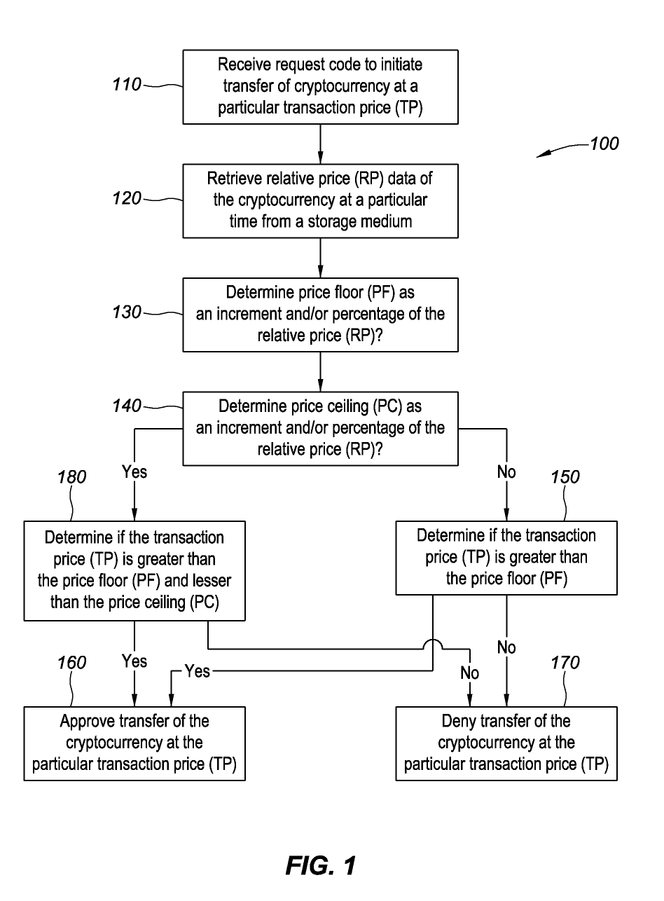

In one embodiment, the transfer of an asset, such as cryptocurrency, may be controlled and/or restricted, for example, to regulate its price, as illustrated in FIG. 1. For example, the price volatility may be controlled and/or restricted by setting a price floor (PF) and/or a price ceiling (PC). A price floor (PF) and/or the price ceiling (PC) may be set as a certain increment or percentage relative to the price (RP) of the cryptocurrency traded at a particular time on a certain cryptocurrency exchange. For example, the particular time for determining the relative price (RP) may be 24 hours from the time that a transaction request was initiated. Alternatively, the particular time may be a scheduled standard time or a certain time zone, for example, the relative price (RP) logged at the prior day at noon Eastern Standard Time (EST). In other embodiments, other times may be used to set the RP. As can be appreciated, the relative price (RP) may be logged or stored remotely, on the blockchain or at a centralized data storage, and retrieved by the smart contract to verify and permit the conditional transfer of cryptocurrency.

In some embodiments, the RP can be more sophisticated. For example, the RP may be a multiple of one or more prior price points. In still other embodiments, the RP may be a function. In particular, the RP may be a function of one or more prior price points.

In still yet other embodiments, the RP may change depending on the particular time period. As just one example, the RP may be a constant number for one time period and a function of one or more prior price points in another time period.

In other embodiments the value of the cryptocurrency may be calculated or controlled in other ways. For example, the value of the cryptocurrency may be pegged to a particular currency, like the US Dollar for example. In such an embodiment, a PF and PC may not even be needed because the value of a currency like the US Dollar is relatively stable. However, PF's and PC's may still be used in embodiments where the value of the cryptocurrency is pegged to a currency.

In yet other embodiments, the value of the cryptocurrency may be pegged to one or more commodities. Commodities include but are not limited to, oil, gas, gold, silver, platinum, diamonds etc.

In yet other embodiments, the cryptocurrency may control price in other ways. For example, in some embodiments, the cryptocurrency could seek to control the price through mining. In most cryptocurrencies, minors are rewarded with coins or fractions of coins for providing the computing power to resolve transactions on the block chain. As the value of the cryptocurrency goes up, the amount of that reward could be reduced. Conversely, as the value of the currency falls, the reward to minors could be increased. This may serve as a type of self-regulation that could provide a feedback loop to help reduce the magnitude of the fulgurations in the price of the cryptocurrency.

In one embodiment, a transfer of cryptocurrency may be permitted if the transaction price (TP) is within the range of approved price values between the price floor (PF) and the price ceiling (PC), both of which are determined based on the relative price (RP). In another embodiment, the smart contract may be programmed with a price floor (PF) without a price ceiling (PC), in which case a transfer of cryptocurrency may be permitted if the transaction price (TP) is greater than the price floor (PF).

For example, assuming that in the last 24 hours, the relative price (RP) of the cryptocurrency was logged at $100, and if a conditional setting for the price floor (PF) was set at one percent (1%) less than the relative price (RP), then the minimum price permitted to approve the transaction and effectuate transfer is $99. Similarly, if a conditional setting for the price ceiling (PC) was set at five percent (5%) more than the relative price (RP), then the maximum price permitted to approve the transaction and effectuate transfer is $105. Consequently, using smart contracts with price floor (PF) and/or price ceiling (PC), control measures may be set in placed to minimize volatility and significant price fluctuations of the cryptocurrency. In this regard, the transfer of possession of cryptocurrency can autonomously be self-regulated.

In embodiments where there is either a PF or a PC set, a transaction time may also be included. For example, a transaction time of 1-day may be set. To this end, if at any time (TT) during that day the value of the cryptocurrency falls within the PF and PC window, the transaction will proceed. If the value of the cryptocurrency never falls within the PF and PC window during the TT, the transaction will expire and will not be executed. In such situations, the parties will have to execute a new contract. As one skilled in the art may appreciate, the TT may be set to any length of time including but not limited to, 1 hour, 1 day, 1 week, 2 months, or even 5 years.

In embodiments that include the ability to set PF and PC's, the parties to the contract may still choose not to use them. For example, the parties could choose to transact at market price and for such transactions the system will ignore any PF or PC's inherent to the system.

In some embodiments, alternative payment methods may be provided to facilitate execution of the contract if the value of the cryptocurrency does not fall within the PF and PC window during the TT. For example, the payee may link a bank account with a country based currency or a credit card or other digital payment method such as PayPal as a backup to the cryptocurrency. If during the TT the value of the cryptocurrency does not fall between the PF and PC, the contract may still execute using the backup funding source.

FIG. 1 illustrates an exemplary flowchart 100 outlining the operation of a system for the conditional transfer of an asset, such as a cryptocurrency, using a floating price floor (PF) and/or a floating price ceiling (PC), according to an embodiment of the present disclosure. In one embodiment, the system may comprise a processor for processing computer readable program instructions, such as programs, software, software application, script, or code. In one embodiment, the system be programmed to receive a request code to initiate transfer of cryptocurrency at a particular transaction price TP (110), retrieve a relative price RP data of the cryptocurrency at a particular time from a storage medium (120), and determine a floating price floor PF as an increment or a percentage of the relative price RP (130). In one embodiment, the system may be programmed to also determine a floating price ceiling PC as an increment or percentage of the relative price RP (140).

One the one hand, if the system is not programmed to determine a floating price ceiling PC, then the system may proceed with determining if the transaction price TP is greater than the floating price floor PF (150). If the transaction price TP is greater than the floating price floor PF, then the system may be programmed to approve the transfer of the cryptocurrency at the particular transaction price TP (160). However, if the transaction price TP is less than the floating price floor PF, then the system may be programmed to deny transfer of the cryptocurrency at the particular transaction price TP (170).

One the other hand, if the system is programmed to determine a floating price ceiling, then the system may proceed with determining if the transaction price TP is greater than the floating price floor PF and lesser than the price ceiling PC (180). If the transaction price TP is greater than the floating price floor PF and lesser than the price ceiling PC, then the system may be programmed to approve the transfer of the cryptocurrency at the particular transaction price TP (160). However, if the transaction price TP is less than the floating price floor PF or greater than the price ceiling PC, then the system may be programmed to deny transfer of the cryptocurrency at the particular transaction price TP (170).

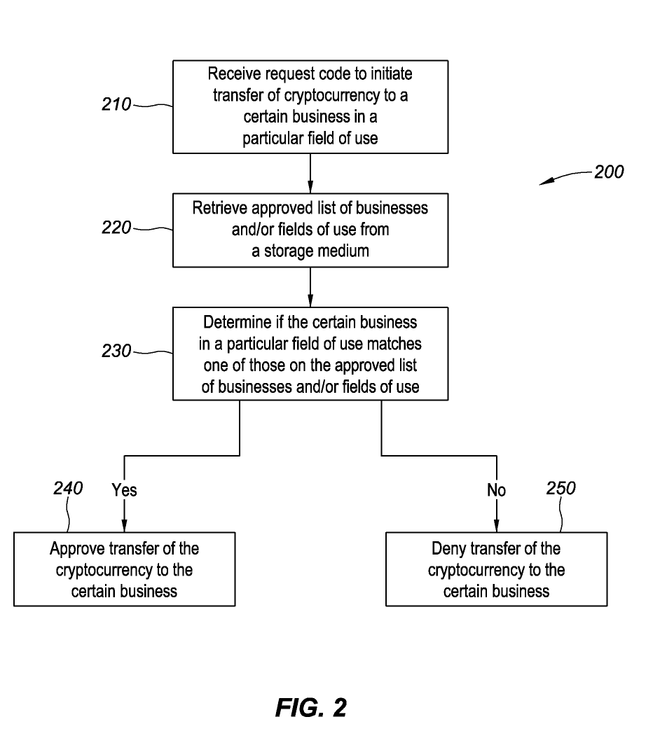

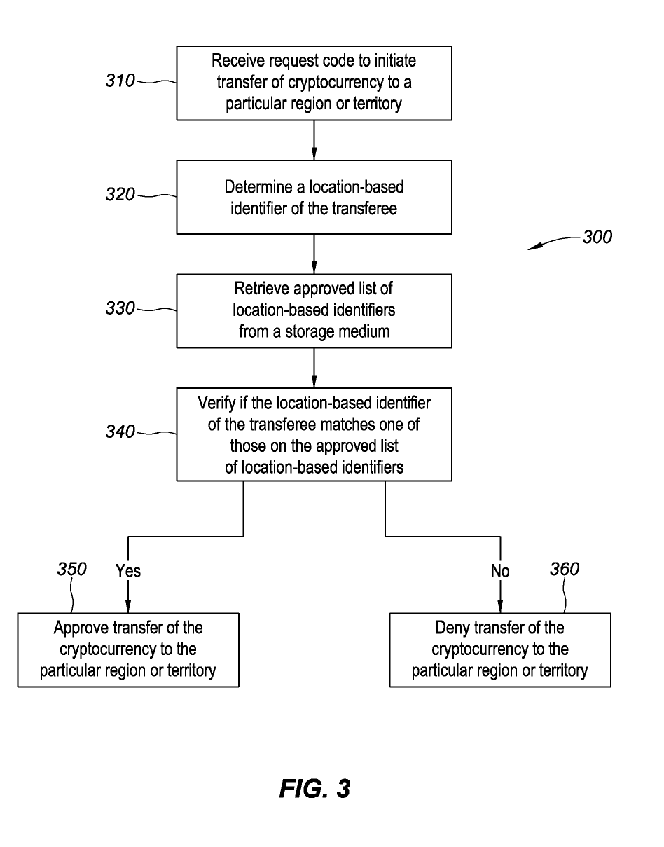

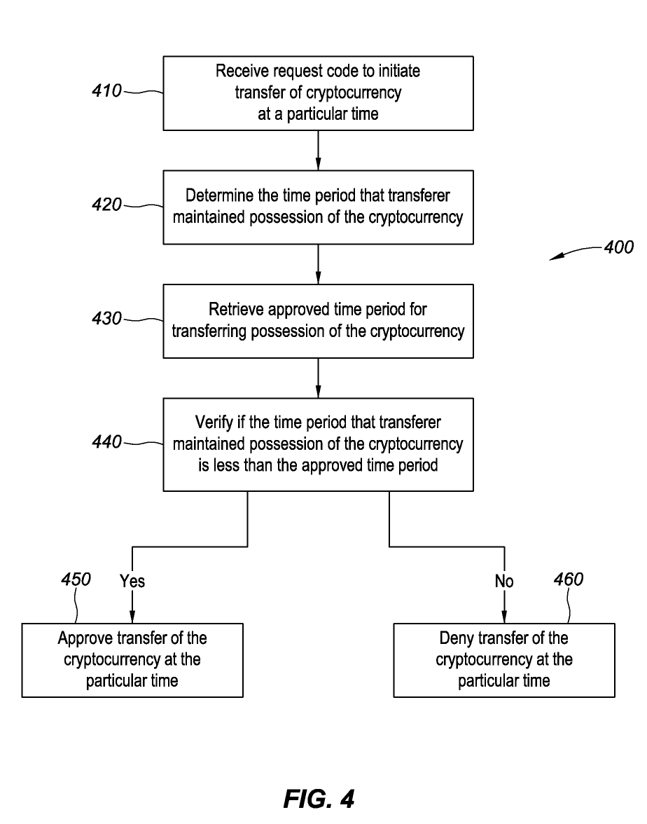

In another embodiment, transfer of cryptocurrency may be controlled and/or restricted, for example, to regulate its use, as illustrated in FIGS. 2-4. As can be appreciated, the smart contract may be programmed to allow the transfer of cryptocurrency within a limited field of use (FIG. 2) and/or within a particular territory (FIG. 3) and/or for a particular period of time (FIG. 4). For example, the smart contract may be programmed to determine a location-based identifier (i.e., IP address) of the transferee, verify if this location-based identifier is among those on an approved list or database of location-based identifiers, and deny transfer if the location-based identifier is not among those approved (i.e. false the transaction to preclude execution). Similarly, the smart contract may be programmed to determine if the transferee (such as a business, merchant or individual) is among an approved list of transferees, for example, the cryptocurrency may be limited to transfer among businesses in a particular field of use, such as for consumer electronics, or for select businesses on an approved list or database of approved businesses. Further, the smart contract may be programmed to determine the time period that the transferor maintained possession of the cryptocurrency, verify that this time period is within a permitted time period for transferring possession of the cryptocurrency, and deny transfer if the transferor's time period exceeds the time period permitted. In one embodiment, the approved list of IP addresses and/or transferees and/or permitted time periods may be stored remotely, on a blockchain or centralized storage medium, and retrieved by the smart contract to verify and approve the conditional transfer of possession of the cryptocurrency.

FIG. 2 illustrates an exemplary flowchart 200 outlining the operation of a system for the conditional transfer of an asset, such as a cryptocurrency, to certain business(es) and/or field(s) of use, according to an embodiment of the present disclosure. The system may be programmed to receive a request code to initiate transfer of cryptocurrency to a certain business in a particular field of use (210), retrieve an approved list of businesses and/or fields of use from a storage medium (220), and determine if the certain business in a particular field of use matches or corresponds to one on the approved list of businesses and/or fields of use (230). As may be appreciated, the identification of a business in a particular field of use may be based on standard international, U.S. federal or U.S. state classification of business activities. If the certain business in a particular field of use matches one of those on the approved list of businesses and/or fields of use, then the system may be programmed to approve the transfer of the cryptocurrency to the certain business (240). However, if the certain business in a particular field of use does not match one of those on the approved list of businesses and/or fields of use, then the system may be programmed to deny the transfer of the cryptocurrency to the certain business (250).

FIG. 3 illustrates an exemplary flowchart 300 outlining the operation of a system for controlling the transfer of an asset, such as a cryptocurrency, to certain geographic territories based on location-based identifier(s), according to an embodiment of the present disclosure. The system may be programmed to receive a request code to initiate transfer of cryptocurrency to a particular region or territory (310), determine a location-based identified, such as an IP address, of the transferee (320), retrieve an approved list of location-based identifiers from a storage medium (330), and verify if the location-based identifier of the transferee matches one of those on the approved list of location-based identifiers (340). If the location-based identifier of the transferee matches one of those on the approved list of location-based identifiers, then the system may be programmed to approve the transfer of the cryptocurrency to the particular region or territory (350). Alternatively, if the location-based identifier of the transferee does not match one of those on the approved list of location-based identifiers, then the system may be programmed to deny the transfer of the cryptocurrency to the particular region or territory (360). In yet another embodiment, the system may retrieve a list of forbidden or disqualified location-based identifiers from the storage medium, and verify if the location-based identifier of the transferee matches or does not match with one of those on the forbidden or disqualified list of location-based identifiers.

FIG. 4 illustrates an exemplary flowchart 400 outlining the operation of a system for the conditional transfer of an asset, such as a cryptocurrency, within a certain transaction time period, according to an embodiment of the present disclosure. The system may be programmed to receive a request code to initiate transfer of cryptocurrency at a particular time (410), determine the time period that transferor had maintained possession of the cryptocurrency (420) (i.e., by retrieving records of when the cryptocurrency was previously purchased), retrieve data of an approved time period for transferring possession of the cryptocurrency (430), and verify if the time period that transferor maintained possession of the cryptocurrency is less than the approved time period (440). In one embodiment, if the time period that transferor maintained possession is less than the approved time period, then the system may be programmed to approve the transfer of the cryptocurrency at the particular time (450). Meanwhile, if the time period that transferor maintained possession is greater than the approved time period, then the system may be programmed to deny the transfer of the cryptocurrency at the particular time (460). In another embodiment, if the time period that transferor maintained possession is less than the approved time period, then the system may be programmed to deny the transfer of the cryptocurrency at the particular time, and if the time period that transferor maintained possession is greater than the approved time period, then the system may be programmed to approve the transfer of the cryptocurrency at the particular time.

In yet another embodiment, a computer-implemented system for blockchain enforced conditional transfer of cryptocurrency is provided. The system comprising: an asset comprising a plurality of private cryptographic keys, each private key being associated with an owner of the asset; a registry comprising a plurality of public cryptographic keys wherein each public key corresponds to a private key in the asset's plurality of private keys, and is associated with a redeem script hash that can be identified within an unspent blockchain transaction; a smart contract comprising at least one condition relating to the automated generation of one or more blockchain transactions to enable a transfer to be made with respect to the asset, the at least one condition defines a minimum price floor (PF) and/or a maximum price ceiling (PC), the automated generation of one or more blockchain transactions to enable a transfer of the asset occurs if a transaction price is greater than the minimum price floor (PF) and/or less than the maximum price ceiling (PC); and a computing agent (i.e., a processor) programmed to evaluate and/or execute the at least one condition of the smart contract.

In one exemplary embodiment, a computer-implemented system for blockchain enforced conditional transfer of cryptocurrency is provided. The system comprising: an asset comprising a plurality of private cryptographic keys, each private key being associated with an owner of the asset; a registry comprising a plurality of public cryptographic keys wherein each public key corresponds to a private key in the asset's plurality of private keys, and is associated with a redeem script hash that can be identified within an unspent blockchain transaction; a smart contract comprising at least one condition relating to the automated generation of one or more blockchain transactions to enable a transfer to be made in respect of the asset, the at least one condition defines a permitted use of the asset, the permitted use corresponding to permitted categories selected from a group consisting of permitted location-based identifiers of a transferee, permitted businesses, and permitted time period, the automated generation of one or more blockchain transactions to enable a transfer of the asset occurs if a transaction category complies with the permitted categories; and a computing agent (i.e., a processor) programmed to evaluate and/or execute the at least one condition of the smart contract.

In another embodiment, a computer-implemented method of restricting a transfer made via a blockchain is provided. The method comprising: defining an asset comprising a plurality of private cryptographic keys, each private key being associated with an owner of the asset; generating a registry comprising a plurality of public cryptographic keys wherein each public key corresponds to a private key in the asset's plurality of private keys, and is associated with a redeem script hash that can be identified within an unspent blockchain transaction; generating a smart contract comprising at least one condition relating to the automated generation of one or more blockchain transactions to enable a transfer to be made in respect of the asset, the at least one condition defines a minimum price floor (PF) and/or a maximum price ceiling (PF), the automated generation of one or more blockchain transactions to enable a transfer of the asset occurs if a transaction price is greater than the minimum price floor (PF) and/or less than the maximum price ceiling (PC); and using a computing agent (i.e., a processor) to evaluate and/or execute the at least one condition of the smart contract.

In yet another embodiment, a computer-implemented method of controlling a transfer made via a blockchain is provided. The method comprising the steps: defining an asset comprising a plurality of private cryptographic keys, each private key being associated with an owner of the asset; generating a registry comprising a plurality of public cryptographic keys wherein each public key corresponds to a private key in the asset's plurality of private keys, and is associated with a redeem script hash that can be identified within an unspent blockchain transaction; generating a smart contract comprising at least one condition relating to the automated generation of one or more blockchain transactions to enable a transfer to be made in respect of the asset, the at least one condition defines a permitted use of the asset, the permitted use corresponding to permitted categories selected from a group consisting of permitted location-based identifiers of a transferee, permitted businesses, and permitted time period, the automated generation of one or more blockchain transactions to enable a transfer of the asset occurs if a transaction category complies with the permitted categories; and using a computing agent (i.e., a processor) to evaluate and/or execute the at least one condition of the smart contract.

In another embodiment, a non-transitory computer-readable medium is provided. The non-transitory computer-readable medium provides instructions, which when read by a computer having a processor and a database, cause the computer to perform operations comprising: defining an asset comprising a plurality of private cryptographic keys, each private key being associated with an owner of the asset; generating a registry comprising a plurality of public cryptographic keys wherein each public key corresponds to a private key in the asset's plurality of private keys, and is associated with a redeem script hash that can be identified within an unspent blockchain transaction; generating a smart contract comprising at least one condition relating to the automated generation of one or more blockchain transactions to enable a transfer to be made in respect of the asset, the at least one condition defines a minimum price floor (PF) and/or a maximum price ceiling (PF), the automated generation of one or more blockchain transactions to enable a transfer of the asset occurs if a transaction price is greater than the minimum price floor (PF) and/or less than the maximum price ceiling (PC); and using a computing agent (i.e., a processor) to evaluate and/or execute the at least one condition of the smart contract.

In yet another embodiment, a non-transitory computer-readable medium is provided. The non-transitory computer-readable medium provides instructions, which when read by a computer having a processor and a database, cause the computer to perform operations comprising: defining an asset comprising a plurality of private cryptographic keys, each private key being associated with an owner of the asset; generating a registry comprising a plurality of public cryptographic keys wherein each public key corresponds to a private key in the asset's plurality of private keys, and is associated with a redeem script hash that can be identified within an unspent blockchain transaction; generating a smart contract comprising at least one condition relating to the automated generation of one or more blockchain transactions to enable a transfer to be made in respect of the asset, the at least one condition defines a permitted use of the asset, the permitted use corresponding to permitted categories selected from a group consisting of permitted location-based identifiers of a transferee, permitted businesses, and permitted time period, the automated generation of one or more blockchain transactions to enable a transfer of the asset occurs if a transaction category complies with (corresponds to) the permitted categories; and using a computing agent (i.e., a processor) to evaluate and/or execute the at least one condition of the smart contract.

While the systems, methods, and machine readable mediums have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. For example, while the systems, methods and machine readable mediums are described in the context of smart contracts, it is understood that all features, functions and structures may be implemented in connection with other computer protocols, systems, methods and machine readable mediums, such as implemented on a centralized or decentralized digital asset trading exchange and/or on a digital wallet. As can be appreciated, the trading exchange and/or digital wallet may be programmed to perform the functions set forth and embodied in this disclosure.

It should also be understood that a variety of changes may be made without departing from the essence of the invention. Such changes are also implicitly included in the description. They still fall within the scope of the invention. It should be understood that this disclosure is intended to yield a patent or patents covering numerous aspects of the invention both independently and as an overall system and in both method and apparatus modes.

Further, each of the various elements of the invention and claims may also be achieved in a variety of manners. This disclosure should be understood to encompass each such variation of an embodiment of any apparatus embodiment, a method, machine-readable medium or process embodiment, or even merely a variation of any element of these.

Particularly, it should be understood that as the disclosure relates to elements of the invention, the words for each element may be expressed by equivalent apparatus terms of method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference. In addition, as to each term used, it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans, incorporated herein by reference.

Further, all claim terms should be interpreted in their most expansive forms so as to afford the applicant the broadest coverage legally permissible. Although the embodiments have been described with reference to the drawings and specific examples, it will readily be appreciated by those skilled in the art that many modifications and adaptations of the processes and apparatuses described herein are possible without departure from the spirit and scope of the embodiments as claimed herein. Thus, it is to be clearly understood that this description is made only by way of example and not as a limitation on the scope of the embodiments as claimed below.

What is claimed is:

1. A computer-implemented system for blockchain enforced conditional transfer of cryptocurrency, the system comprising:
an asset comprising a plurality of private cryptographic keys, wherein each private cryptographic key in the plurality of private cryptographic keys is associated with an owner of the asset;
a registry comprising a plurality of public cryptographic keys wherein each public cryptographic key in the plurality of public cryptographic keys corresponds to a private cryptographic key in the asset's plurality of private keys, and is associated with a redeem script hash that is identified within an unspent blockchain transaction;
a smart contract comprising at least one condition relating to the automated generation of one or more blockchain transactions to enable a transfer to be made with respect to the asset, wherein the at least one condition defines a minimum price floor, and wherein the automated generation of one or more blockchain transactions to enable a transfer of the asset occurs if a transaction price is greater than the minimum price floor; and
one or more processors programmed to execute the at least one condition of the smart contract.

2. The computer-implemented system of claim 1, wherein the automated generation of one or more blockchain transactions to enable a transfer of the asset does not occur if the transaction price is less than the minimum price floor.

3. The computer-implemented system of claim 1, further comprising a storage medium for storing a price of the asset at a particular time, wherein the minimum price floor is a certain increment or percentage relative to the price of the asset at the particular time.

4. The computer-implemented system of claim 3, wherein the minimum price floor is pegged to a price of a certain currency or commodity.

5. The computer-implemented system of claim 1,
wherein the at least one condition further defines a maximum price ceiling,
wherein the automated generation of one or more blockchain transactions to enable a transfer of the asset occurs if a transaction price is greater than the minimum price floor and less than the maximum price ceiling, and
wherein the minimum price floor and the maximum price ceiling are each at a certain increment or percentage relative to a price of the asset at a particular time.

6. A computer-implemented system for blockchain enforced conditional transfer of cryptocurrency, the system comprising:
an asset comprising a plurality of private cryptographic keys, wherein each private cryptographic key in the plurality of private cryptographic keys is associated with an owner of the asset;
a registry comprising a plurality of public cryptographic keys wherein each public cryptographic key in the plurality of public cryptographic keys corresponds to a private cryptographic key in the asset's plurality of private cryptographic keys, and is associated with a redeem script hash that is identified within an unspent blockchain transaction;
a smart contract comprising at least one condition relating to the automated generation of one or more blockchain transactions to enable a transfer to be made in respect of the asset, wherein the at least one condition defines a permitted use of the asset, and wherein the permitted use corresponding to a permitted category selected from a group consisting of permitted location-based identifiers of a transferee, permitted businesses, and permitted time period, and wherein the automated generation of one or more blockchain transactions to enable a transfer of the asset occurs if a transaction category complies with the permitted category; and
one or more processors adapted to execute the at least one condition of the smart contract.

7. The computer-implemented system of claim 6, wherein the automated generation of one or more blockchain transactions to enable a transfer of the asset does not occur if the transaction category does not comply with the permitted category.

8. The computer-implemented system of claim 6, wherein the permitted category for permitted location-based identifiers is at least one approved IP address.

9. The computer-implemented system of claim 6, wherein the permitted category for permitted businesses is based on a standard classification for businesses.

10. The computer-implemented system of claim 6, wherein the at least one condition further defines a minimum price floor, and wherein the automated generation of one or more blockchain transactions to enable a transfer of the asset occurs if a transaction price is greater than the minimum price floor.

11. The computer-implemented system of claim 10, further comprising a storage medium for storing a price of the asset at a particular time, the minimum price floor is a certain increment or percentage relative to the price of the asset at the particular time.

12. The computer-implemented system of claim 6, wherein the at least one condition further defines a maximum price ceiling, and wherein the automated generation of one or more blockchain transactions to enable a transfer of the asset occurs if a transaction price is less than the maximum price ceiling.

13. The computer-implemented system of claim 12, further comprising a storage medium for storing a price of the asset at a particular time, the maximum price ceiling is a certain increment or percentage relative to the price of the asset at the particular time.

14. A computer-implemented method of restricting a transfer made via a blockchain, the method comprising:
defining an asset comprising a plurality of private cryptographic keys, wherein each private cryptographic key in the plurality of private cryptographic keys is associated with an owner of the asset;
generating a registry comprising a plurality of public cryptographic keys wherein each public cryptographic key in the plurality of public cryptographic keys corresponds to a private cryptographic key in the asset's plurality of private cryptographic keys, and is associated with a redeem script hash that is identified within an unspent blockchain transaction;
generating a smart contract comprising at least one condition relating to the automated generation of one or more blockchain transactions to enable a transfer to be made in respect of the asset, wherein the at least one condition defines a minimum price floor, and wherein the automated generation of one or more blockchain transactions to enable a transfer of the asset occurs if a transaction price is greater than the minimum price floor; and
using one or more processors to execute the at least one condition of the smart contract.

15. The computer-implemented method of claim 14, wherein the at least one condition further defines a maximum price ceiling, and wherein the automated generation of one or more blockchain transactions to enable a transfer of the asset occurs if a transaction price is greater than the minimum price floor and less than the maximum price ceiling.

16. The computer-implemented method of claim 14, further comprising retrieving a price of the asset at a particular time from a storage medium, and determining the minimum price floor as a certain increment or percentage relative to the price of the asset at the particular time.

17. The computer-implemented method of claim 14, wherein the at least one condition further defines a permitted use of the asset, the permitted use corresponding to a permitted category selected from a group consisting of permitted location-based identifiers of a transferee, permitted businesses, and permitted time period, and wherein the automated generation of one or more blockchain transactions to enable a transfer of the asset occurs if a transaction category corresponds to the permitted category.

18. The computer-implemented method of claim 17, wherein the automated generation of one or more blockchain transactions to enable a transfer of the asset does not occur if the transaction category does not comply with the permitted category.

19. The computer-implemented method of claim 17, wherein the permitted category for permitted location-based identifiers is at least one approved IP address.

20. The computer-implemented method of claim 17, further comprising verifying if the transaction category corresponds to the permitted category.
